(19) United States
(12) Patent Application Publication
(10) Pub. No.: US 2012/0021302 A1
(43) Pub. Date: Jan. 26, 2012

(54) OXYGEN-CONSUMING ELECTRODE

(75) Inventors: Andreas Bulan, Langenfeld (DE); Rainer Weber, Odenthal (DE)

(73) Assignee: Bayer MaterialScience AG, Leverkusen (DE)

(21) Appl. No.: 13/177,656

(22) Filed: Jul. 7, 2011

(30) Foreign Application Priority Data
Jul. 20, 2010 (DE) 102010031571.0

(51) Int. Cl. H01M 4/90; H01M 8/02; C25B 11/08; H01M 8/22

(52) U.S. Cl. 429/405; 429/530; 204/290.11; 204/290.1

(57) ABSTRACT

The present invention relates to an oxygen-consuming electrode comprising at least one support structure having a surface and a gas diffusion coating having a catalytically active component disposed on the surface. The coating contains at least one fluorine-containing polymer, a silver compound, selected from the group consisting of silver particles, reducible silver compounds, and mixtures thereof, and a hydrophilic caustic alkali-resistant filler which is electrically nonconductive or has a poor electrical conductivity and has an average particle diameter from 5 to 200 μm.

### CROSS-REFERENCES TO RELATED APPLICATIONS

Priority is claimed to German Patent Application No. 10 2010 031 571.0, filed Jul. 20, 2010, which is incorporated herein by reference in its entirety for all useful purposes.

### BACKGROUND OF THE INVENTION

The invention proceeds from oxygen-consuming electrodes known per se which are configured as sheet-like gas diffusion electrodes and usually comprise an electrically conductive support and a gas diffusion layer having a catalytically active component.

Various proposals for the operation of oxygen-consuming electrodes in electrolysis cells on an industrial scale are fundamentally known from the prior art. The basic idea is to replace the hydrogen-evolving cathode of the electrolysis (for example in chloralkali electrolysis) by the oxygen-consuming electrode (cathode). An overview of possible cell designs and solutions may be found in the publication by Moussallem et al., “Chlor-Alkali Electrolysis with Oxygen Depolarized Cathodes: History, Present Status and Future Prospects”, J. Appl. Electrochem. 38 (2008) 1177-1194.

The oxygen-consuming electrode, hereinafter also referred to as OCE for short, has to meet a series of requirements in order to be able to be used in industrial electrolyzers. Thus, the catalyst and all other materials used have to be chemically stable to sodium hydroxide solution having a concentration of about 32% by weight and to pure oxygen at a temperature of typically 80-90° C. A high degree of mechanical stability is likewise required, since the electrodes are installed and operated in electrolyzers having an electrode area of usually more than 2 m² (industrial size). Further properties are: a high electrical conductivity, a low layer thickness, a high internal surface area and a high electrochemical activity of the electrocatalyst. Suitable hydrophobic and hydrophilic pores and a corresponding pore structure are likewise necessary in order to conduct gas and electrolyte, and also gastightnesses so that gas and liquid spaces remain separated from one another. The long-term stability and low production costs are further particular requirements which an industrially usable oxygen-consuming electrode has to meet.

A further development direction for use of the OCE technology in chloralkali electrolysis is the ion-exchange membrane which separates the anode space from the cathode space in the electrolysis cell without the sodium hydroxide solution gap coming into direct contact with the OCE. This arrangement is also referred to as zero gap arrangement in the prior art. This arrangement is usually also employed in fuel cell technology. A disadvantage here is that the sodium hydroxide formed has to be conveyed through the OCE to the gas side and subsequently flows downward at the OCE. Here, there must be no blockage of the pores in the OCE by the sodium hydroxide or crystallization of sodium hydroxide in the pores. It has been found that very high sodium hydroxide concentrations can also arise here, and the ion-exchange membrane is not stable to these high concentrations in the long term (Lipp et al, J. Appl. Electrochem. 35 (2005)1015—Los Alamos National Laboratory “Peroxide formation during chlor-alkali electrolysis with carbon-based ODC”).

A conventional oxygen-consuming electrode typically consists of an electrically conductive support element to which the gas diffusion layer having a catalytically active component has been applied. As hydrophobic component, use is generally made of polytetrafluoroethylene (PTFE) which additionally serves as polymeric binder for the catalyst. In the case of electrodes having a silver catalyst, the silver serves as hydrophilic component. In the case of carbon-supported catalysts, a carbon having hydrophilic pores through which liquid transport can take place is used as support.

The reduction of oxygen proceeds in a three-phase region in which gas phase, liquid phase and solid catalyst are simultaneously present.

Gas transport occurs through the pores into the hydrophobic matrix. The hydrophilic pores become filled with liquid and transport of water to the catalytic centres and of hydroxide ions from the catalytic centres occurs via these pores. Since oxygen has only limited solubility in the aqueous phase, sufficient water-free pores would have to be available for transport of the oxygen.

Many compounds have been described as catalyst for the reduction of oxygen.

Thus, the use of palladium, ruthenium, gold, nickel, oxides and sulphides of transition metals, metal porphyrins and phthalocyanines, and perovskites have been reported as catalyst for oxygen-consuming electrodes.

However, only platinum and silver have attained practical importance as catalyst for the reduction of oxygen in alkaline solutions.

Platinum has a very high catalytic activity for the reduction of oxygen. Owing to the high cost of platinum, this is used exclusively in supported form. The preferred support material is carbon. Carbon conducts electric current to the platinum catalyst. The pores in the carbon particles can be made hydrophilic by oxidation of the surfaces and thus becomes suitable for the transport of water. OCEs having carbon-supported platinum catalysts display good performance. However, the resistance of carbon-supported platinum electrodes in long-term operation is unsatisfactory, presumably because platinum also catalyzes the oxidation of the support material. Carbon additionally promotes the undesirable formation of H₂O₂.

OCEs having a platinum content of from 5 g/m² to 50 g/m² have been described. Despite the low concentration, the cost of the platinum catalyst is still so high that it stands in the way of industrial use. Silver likewise has a high catalytic activity for the reduction of oxygen.

OCEs comprising carbon-supported silver usually have silver concentrations of 20-50 g/m². Although the carbon-supported silver catalysts are more durable than the corresponding platinum catalysts, the long-term stability under the conditions in an oxygen-consuming electrode, particularly when used for chloralkali electrolysis, is limited.

Various publications describe the production of catalysts based on silver on polytetrafluoroethylene (PTFE). Such a process is described, for example, in EP0115845B1.

U.S. Pat. No. 7,566,388 B2 describes a catalyst which is produced by precipitation and reduction of a noble metal and the oxide of a rare earth metal in combination with an alkaline earth metal oxide onto a support. A higher activity of the catalyst is achieved by means of this combination. As support material, use is made of carbon which limits the resistance of these catalysts.

In the production of OCEs having an unsupported silver catalyst, the silver can be introduced at least partly in the form of silver oxides which are then reduced to metallic silver. The reduction is carried out either during start-up of the electrolysis, in which conditions for reduction of silver compounds already prevail, or in a separate step by a preferably electrochemical route.

In industrial use with repeated start-ups and shutdowns, partial oxidation of silver to silver oxide occurs after switching off the electrolysis current. The silver oxide formed can, for example, become detached from the surface and block the pore system of the OCE. In the case of silver catalysts having a particularly fine morphology, for example nanosize silver, this leads over time to a deterioration in the performance. WO2008036962A2 teaches that the long-term stability of nanosize silver catalysts can be significantly improved by inclusion of zirconium dioxide particles produced in situ in the pores of nanosize silver. However, the process for producing these catalysts is complicated and requires the use of nanosize silver, which is likewise complicated to produce.

In the manufacture of oxygen-consuming electrodes having unsupported silver catalysts, a distinction can be made in principle between dry and wet manufacturing processes.

In the dry processes, a mixture of catalysts and polymeric component is processed by means of a mixer having fast-running beaters to give a mixture which is applied to the electrically conductive support element and pressed at room temperature. Such a process is described in EP 1728896 A2. The intermediate described in EP 1728896 consists of 3-15 parts of PTFE, 70-95 parts of silver oxide and 0-15 parts of silver metal powder.

In the wet manufacturing processes, an intermediate in the form of a paste or a suspension containing fine silver particles and a polymeric component is used. Water is generally used as suspension medium, but other liquids such as alcohols or mixtures thereof with water can also be used. In the production of the paste or suspension, it is possible to add surface-active substances in order to increase the stability of the paste/suspension. The pastes are applied to the support element by means of screen printing or calendering, while the less viscous suspensions are usually sprayed onto the support element. After drying, sintering is carried out at temperatures in the region of the melting point of the polymer. Here, the auxiliaries such as emulsifiers or thickeners which have been added are removed. Such a process is described, for example, in US20060175195 A1. The ratio of PTFE to silver in the intermediate corresponds to the ratio usual in the dry process.

The above-described OCEs having unsupported silver catalysts have a good long-term stability under the conditions of the electrolysis of alkali metal chlorides. However, a disadvantage is the high silver content from 1000 to 2500 g/m².

Silver is a rare element and is present in the earth's crust in a proportion of only 0.08 ppm. Silver is a sought-after metal for jewellery and many industrial applications. The limited availability and high demand result in a high price of silver. This incurs high costs for the OCE having unsupported silver catalysts, and these stand in the way of economical use of the OCE technology.

It is an object of the present invention to provide an oxygen-consuming electrode, in particular for use in chloralkali electrolysis, which at a reduced silver content has at least the same performance and long-term stability as a conventional SBE.

### BRIEF DESCRIPTION OF THE INVENTION

The invention relates to an oxygen-consuming electrode, in particular for use in chloralkali electrolysis having a novel catalyst coating. The invention further relates to a production process for the oxygen-consuming electrode and its use in chloralkali electrolysis or in fuel cells.

The object is achieved by an oxygen-consuming electrode in which part of the silver is replaced by filler particles which are poorly electrically conductive and have a specific particle size (diameter).

One embodiment of the invention provides an oxygen-consuming electrode at least comprising a support in the form of a sheet-like structure and a coating having a gas diffusion layer and a catalytically active component, characterized in that the coating contains at least one fluorine-containing polymer, silver in the form of silver particles or a reducible silver compound and a hydrophilic caustic alkali-resistant filler which is electrically nonconductive or has a poor electrical conductivity and has an average particle diameter (d(0.5), volume-based) in the range from 5 to 200 μm.

Another embodiment of the present invention is a an oxygen-consuming electrode comprising at least one support structure having a surface and a gas diffusion coating having a catalytically active component disposed on the surface, wherein the coating comprises: at least one fluorine-containing polymer, a silver compound, selected from the group consisting of silver particles, reducible silver compounds, and mixtures thereof, and a hydrophilic caustic alkali-resistant filler which is electrically nonconductive or has a poor electrical conductivity and has an average particle diameter from 5 to 200 μm.

Yet another embodiment of the present invention is a chloralkali electrolysis apparatus containing an oxygen-consuming electrode according to any embodiment described herein as an oxygen-consuming cathode.

Yet another embodiment of the present invention is a fuel cell containing an oxygen-consuming electrode according any embodiment described herein.

Yet another embodiment of the present invention is a metal/air battery containing an oxygen-consuming electrode according any embodiment described herein.

### DETAILED DESCRIPTION OF THE INVENTION

The average particle diameter of the filler is preferably from 10 to 150 μm.

The coating preferably comprises from 0.5 to 20 parts by weight, preferably from 2 to 10 parts by weight, of the fluorine-containing polymer, from 30 to 90 parts by weight, preferably from 30 to 70 parts by weight, of silver in the form of silver particles and/or a reducible silver compound and from 5 to 60 parts by weight, preferably from 15 to 50 parts by weight, of the hydrophilic caustic alkali-resistant filler which is electrically nonconductive or has a poor electrical conductivity.

The filler replaces part of the catalytically active silver, but does not itself have to be catalytically active. The filler is, in particular, hydrophilic like silver; the ratio of hydrophobic material to hydrophilic material in the electrode is not altered significantly by the filler. The filler is present in the form of discrete particles and should not form, in particular, a chemical compound or alloy with the catalytically active silver. The average particle size (particle diameter) of the filler is preferably at least 10 μm and therefore in the order of magnitude or above the particle size of the silver-containing catalysts. The filler is electrically nonconductive or has a poor electrical conductivity. The conductivity of the filler is preferably <1000 siemens/cm, particularly preferably <100 siemens/cm. As filler, it is in principle possible to use all materials which are stable in combination with silver catalysts under the conditions of an oxygen-consuming electrode. Such materials are, for example, alkali-resistant metal oxides, metal nitrides and metal- or diamond-like carbides.

A particularly preferred filler is, for example, zirconium oxide (ZrO₂). Zirconium oxide in various particle sizes is readily available and is a conventional starting material for technical ceramics and high-temperature-resistant components. Zirconium oxide does not have any catalytic activity in respect of the electrolytic reduction of oxygen. In the temperature range in which OCEs are used, zirconium oxide is electrically nonconductive. Surprisingly, zirconium oxide can, despite the absence of catalytic activity, replace up to 50% of the silver in an OCE without the performance of the OCE being reduced.

Particular preference is given to using a zirconium oxide in which the particle size distribution has a d (0.1)>10 μm and a d (0.9)<150 μm (figures in percent by volume Q3).

The OCE can be produced from the precursor by means of techniques known per se using the appropriate suspensions, pastes or powder mixtures in a wet or dry process.

The aqueous suspension or paste used in the wet process is, for example, produced from finely divided silver, a suspension containing fluorine-containing polymer (polymer:

for example PTFE) and optionally a thickener (for example methylcellulose) and an emulsifier by mixing of the components by means of a high-speed mixer. For this purpose, a suspension in water and/or alcohol is firstly produced from finely divided silver, the filler and optionally a thickener (for example methylcellulose). This suspension is then mixed with a suspension of a fluorine-containing polymer, as is commercially available, for example, under the trade name Dyneon™ TF5035R, to give an intermediate according to the invention. The intermediate in the form of an emulsion or paste is then applied to a support by known methods, dried, and can then optionally be compacted and is then sintered.

The intermediate used, for example, in the dry process in the form of a powder mixture is produced by mixing a mixture of RIFE or another fibril-like, chemically resistant polymer and silver oxide particles and/or silver particles using fast-running beaters. For example, mixing can be carried out in two or more steps. Here, the material can be passed through a sieve between the mixing steps in order to remove relatively coarse particles and agglomerates which are still present from the mixing process. In a further variant, the powder mixture can be compacted in an intermediate step, for example by means of a calender, and the resulting flakes can again be processed in a mixer to give a powder. This operation, too, can in principle be repeated a number of times. It has to be ensured in each of the milling operations that the temperature of the mixture is maintained in the range from 35 to 80° C., particularly preferably from 40 to 55° C.

A zirconium dioxide having the above-described particle size, for example, is then added to the mixture.

The addition can take place at the beginning of the mixing operation. It is possible to mill all components together by, for example, supplying the mixer with a mixture of the components hydrophobic polymer, silver and/or silver oxide and the filler.

However, in the case of multistage mixing with intermediate sieving and optionally compaction, the filler can also be added between two mixing operations.

The powder mixture is then applied to a support and compacted in a known manner.

Apart from the zirconium dioxide mentioned by way of example, there are many further materials which can be used as filler for the intermediates according to the invention and the OCEs produced therefrom.

Examples of particularly suitable materials are alkali-resistant metal oxides such as TiO₂, Fe₂O₃, Fe₃O₄, NiO₂, Y₂O₃, Mn₂O₃, Mn₅O₈, WO₃, CeO₂ and further oxides of the rare earths, and also mixed metal oxides such as rutiles, spinels CoAl₂O₄, Co(AlCr)₂O₄, inverse spinels, (Co,Ni,Zn)₂(Ti,Al)O₄, perovskites such as LaNiO₃, ZnFe₂O₄ (pigment yellow 119), Cu(FeCr)₂O₄.

Boron nitride, silicon nitride and other metal nitrides such as TiN, AlN and also diamond- and metal-like carbides such as silicon carbide, TiC, CrC, WC, Cr₃C₂, TiCN are likewise suitable.

The fillers mentioned can be used as pure substances or in combinations of two or more components.

Preference is given to an oxygen-consuming electrode in which zirconium oxide, tungsten oxide or a mixture of zirconium oxide and tungsten oxide is selected as filler.

The fillers added can also optionally be catalytically active. In the OCEs produced from the abovementioned starting materials, the oxygen is reduced first and foremost over the silver catalysts. The catalysis can be aided by the fillers.

While the composition of the fillers is of subordinate importance, as long as the materials are stable in the long term under the conditions of an oxygen-consuming electrode, the particle size has a great influence on the conductivity of the OCE. It has been found that the conductivity of the OCE is significantly reduced in the presence of a large number of particles having a diameter of >1 μm. Larger particles do not, to a certain extent, decrease the performance of the OCE, but it is obvious that large particles will reduce the volume of the available catalyst layer. The particle should be appropriate to the thickness of the electrode and the mesh opening of the support element, which sets limits to the maximum particles sizes. In the case of a mesh opening of the support element of, for example, 500 μm, the maximum particle size of the filler should not exceed half the mesh opening, and the proportion of particles >250 μm should be less than 50%. A similar situation also applies to the electrode thickness in relation to the particle diameter. Thus, in the case of an electrode thickness of 600 μm, the maximum particle diameter of the filler should not exceed 50% of the electrode thickness, i.e. the proportion of particles with a diameter of >200 μm should be less than 50%.

Particular preference is given to an oxygen-consuming electrode in which the proportion of fines having a particle diameter of <4 μm in the filler is not more than 20%, preferably not more than 15%, particularly preferably not more than 10%.

Particular preference is also given to an oxygen-consuming electrode in which the proportion of fines having a particle diameter of <1 μm in the filler is not more than 10%, preferably not more than 5%, particularly preferably not more than 2%.

(All particle sizes are measured after ultrasound treatment by means of laser light scattering using a method analogous to ISO 13320, all figures reported are in percent by volume, Q₃)

Some of the materials suitable as fillers are also used for ceramics, surface coatings and/or pigments and are available industrially.

The oxygen-consuming electrodes of the invention can be used, for example, in chloralkali electrolysis in cells having an alkali gap between oxygen-consuming electrode and ion-exchange membrane or in direct contact with the ion-exchange membrane or in cells having a hydrophilic material in the gap between ion-exchange membrane and oxygen-consuming electrode, comparable to the process described in U.S. Pat. No. 6,117,286 A1.

The oxygen-consuming electrode of the invention is preferably connected as cathode, in particular in an electrolysis cell for the electrolysis of alkali metal chlorides, preferably sodium chloride or potassium chloride, particularly preferably sodium chloride.

As an alternative, the oxygen-consuming electrode of the invention can preferably be connected as cathode in an alkaline fuel cell.

The invention therefore further provides for the use of the oxygen-consuming electrode of the invention for the reduction of oxygen in an alkaline medium, in particular as oxygen-consuming cathode in electrolysis, in particular in chloralkali electrolysis, or as electrode in a fuel cell or as electrode in a metal/air battery.

The OCE produced according to the invention is particularly preferably used in chloralkali electrolysis and here especially in the electrolysis of sodium chloride (NaCl).

The invention further provides an electrolysis apparatus, in particular for chloralkali electrolysis, which has a novel oxygen-consuming electrode as described above as oxygen-consuming cathode.

The invention is illustrated by the examples, without being restricted thereby.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

### Example 1

1.472 kg of a powder mixture consisting of 5% by weight of Dyneon type TF2053Z PTFE powder, 61.6% by weight of silver(I) oxide, 7% by weight of silver powder grade 331 from Ferro and 26.4% by weight of zirconium dioxide (special grade from Merck Chemicals, Technipur, average particle size (d (0.5), percent by volume) 22 μm, d (0.1) 15 μm, d (0.9) 32.5 μm) were mixed in a type R02 mixer from Eirich, equipped with a star agitator as mixing element, at a rotational speed of 5000 rpm for 3.5 minutes. The temperature of the powder mixture remained below 48° C. during the operation.

After mixing, the powder mixture was sieved through a sieve having a mesh opening of 1.0 mm.

The sieved powder mixture was subsequently applied to a gauze made of nickel wires having a wire thickness of 0.14 mm and a mesh opening of 0.5 mm. Application was effected with the aid of a 2 mm thick template, with the powder being applied using a sieve having a mesh opening of 1 mm. Excess powder which projected over the thickness of the template was removed by means of a scraper. After removal of the template, the support with the applied powder mixture was pressed by means of a roller press at a pressing force of 0.58 kN/cm. The gas diffusion electrode was taken from the roller press.

The oxygen-consuming cathode produced in this way was used in the electrolysis of a sodium chloride solution using a DuPONT N982WX ion-exchange membrane and a sodium hydroxide solution gap between OCE and membrane of 3 mm. A titanium anode consisting of expanded metal having a commercial DSA® coating from Denora was used as anode. The cell voltage at a current density of 4 kA/m², an electrolyte temperature of 90° C. and a sodium hydroxide concentration of 3% by weight was 2.05 V.

### Example 2

2 kg of a powder mixture consisting of 5% by weight of Dyneon type TF2053Z PTFE powder, 44.0% by weight of silver(I) oxide, 7% by weight of silver powder grade 331 from Ferro and 44.4% by weight of zirconium dioxide (special grade from Merck Chemicals, Technipur, average particle size (d (0.5), percent by volume) 22 μm, d (0.1) 15 μm, d (0.9) 32.5 μm) were mixed in a type R02 mixer from Eirich, equipped with a star agitator as mixing element, at a rotational speed of 5000 rpm for 5 minutes. The temperature of the powder mixture remained below 41° C. during the operation.

After mixing, the powder mixture was sieved through a sieve having a mesh opening of 1.0 mm.

The sieved powder mixture was subsequently applied to a gauze made of nickel wires having a wire thickness of 0.14 mm and a mesh opening of 0.5 mm. Application was effected with the aid of a 2 mm thick template, with the powder being applied using a sieve having a mesh opening of 1 mm. Excess powder which projected over the thickness of the template was removed by means of a scraper. After removal of the template, the support with the applied powder mixture was pressed by means of a roller press at a pressing force of 0.63 kN/cm. The gas diffusion electrode was taken from the roller press.

The oxygen-consuming cathode produced in this way was used in the electrolysis of a sodium chloride solution using a DuPONT N982WX ion-exchange membrane and a sodium hydroxide solution gap between OCE and membrane of 3 mm. A titanium anode consisting of expanded metal having a commercial DSA® coating from Denora was used as anode. The cell voltage at a current density of 4 kA/m², an electrolyte temperature of 90° C. and a sodium hydroxide concentration of 32% by weight was 2.22 V.

### Example 3

0.16 kg of a powder mixture consisting of 5% by weight of Dyneon type TF2053Z PTFE powder, 61.6% by weight of silver(I) oxide, 7% by weight of silver powder grade 331 from Ferro and 26.4% by weight of tungsten oxide WO₃ yellow HQ (from H. C. Starck, average particle size (d (0.5), percent by volume) 71 μm, d (0.1) 31 μm, d (0.9) 133 μm, proportion <10 μm less than 3%, proportion >1 μm less than 1%) was mixed in a mixer from IKA in four intervals of 15 sec. The temperature of the powder mixture remained below 49° C. during the operation. After mixing, the powder mixture was sieved through a sieve having a mesh opening of 1.0 mm.

The sieved powder mixture was subsequently applied to a gauze made of nickel wires having a wire thickness of 0.14 mm and a mesh opening of 0.5 mm. Application was effected with the aid of a 2 mm thick template, with the powder being applied using a sieve having a mesh opening of 1 mm. Excess powder which projected over the thickness of the template was removed by means of a scraper. After removal of the template, the support with the applied powder mixture was pressed by means of a roller press at a pressing force of 0.55 kN/cm. The gas diffusion electrode was taken from the roller press.

The oxygen-consuming cathode produced in this way was used in the electrolysis of a sodium chloride solution using a DuPONT N982WX ion-exchange membrane and a sodium hydroxide solution gap between OCE and membrane of 3 mm. The cell voltage at a current density of 4 kA/m², an electrolyte temperature of 90° C. and a sodium hydroxide concentration of 32% by weight was 2.13 V.

### Example 4

### Comparison value/OCE having filler which is too fine

0.16 kg of a powder mixture consisting of 5% by weight of Dyneon type TF2053Z PTFE powder, 61.6% by weight of silver(I) oxide, 7% by weight of silver powder grade 331 from Ferro and 26.4% by weight of zirconium oxide from H. C. Starck, StarCeram Z16® (average particle size (d (0.5), percent by volume) 4.1 μm, d (0.1) 0.3 μm, d (0.9) 16 μm, and a proportion <1 μm of 40%) was mixed in a mixer from IKA 4 times for 15sec in each case. The temperature of the powder mixture remained below 43° C. during the operation.

After mixing, the powder mixture was sieved through a sieve having a mesh opening of 1.0 mm.

The sieved powder mixture was subsequently applied to a gauze made of nickel wires having a wire thickness of 0.14 mm and a mesh opening of 0.5 mm. Application was effected with the aid of a 2 mm thick template, with the powder being applied using a sieve having a mesh opening of 1 mm. Excess powder which projected over the thickness of the template was removed by means of a scraper. After removal of the template, the support with the applied powder mixture was pressed by means of a roller press at a pressing force of 0.49 kN/cm. The gas diffusion electrode was taken from the roller press.

The oxygen-consuming cathode produced in this way was used in the electrolysis of a sodium chloride solution using a DuPONT N982WX ion-exchange membrane and a sodium hydroxide solution gap between OCE and membrane of 3 mm. The electrolyte temperature was 90° C., and the sodium hydroxide concentration was 32% by weight.

At a voltage of a little above 2.48 volt, an electrolysis current of 15 A flowed briefly; this corresponds to 1.5 kA/m². The experiment was stopped.

### Example 5

### Comparative value using conventional OCE

3.5 kg of a powder mixture consisting of 7% by weight of PTFE powder, 88% by weight of silver(I) oxide and 5% by weight of silver powder grade 331 from Ferro were mixed in a type R02 mixer from Eirich, equipped with a star agitator as mixing element, at a rotational speed of 5000 rpm in such a way that the temperature of the powder mixture did not exceed 55° C. This was achieved by the mixing operation being interrupted and the mixing temperature being cooled down. Mixing was carried out a total of three times. After mixing, the powder mixture was sieved using a mesh opening of 1.0 mm.

The sieved powder mixture was subsequently applied to a gauze made of nickel wires having a wire thickness of 0.14 mm and a mesh opening of 0.5 mm. Application was effected with the aid of a 2 mm thick template, with the powder being applied using a sieve having a mesh opening of 1 mm. Excess powder which projected over the thickness of the template was removed by means of a scraper. After removal of the template, the support with the applied powder mixture was pressed by means of a roller press at a pressing force of 0.5 kN/cm. The gas diffusion electrode was taken from the roller press.

The oxygen-consuming cathode produced in this way was used in the electrolysis of a sodium chloride solution using a DuPONT N982WX ion-exchange membrane and a sodium hydroxide solution gap between OCE and membrane of 3 mm. The cell voltage at a current density of 4 kA/m², an electrolyte temperature of 90° C. and a sodium hydroxide concentration of 32% by weight was 2.05 V.

1. An oxygen-consuming electrode comprising a support structure and a gas diffusion coating having a catalytically active component disposed on the support structure, wherein the coating comprises:
at least one fluorine-containing polymer,
a silver compound selected from the group consisting of silver particles, reducible silver compounds, and mixtures thereof, and
a hydrophilic caustic alkali-resistant filler which is electrically nonconductive or has a poor electrical conductivity and has an average particle diameter from 5 to 200 μm.

2. The oxygen-consuming electrode according to claim 1, wherein the coating comprises from 0.5 to 20 parts by weight of the at least one fluorine-containing polymer, from 30 to 90 parts by weight of the silver compound, and from 5 to 60 parts by weight of the hydrophilic caustic alkali-resistant filler.

3. The oxygen-consuming electrode according to claim 2, wherein the coating comprises from 2 to 10 parts by weight of the at least one fluorine-containing polymer.

4. The oxygen-consuming electrode according to claim 2, wherein the coating comprises from 15 to 50 parts by weight of the hydrophilic caustic alkali-resistant filler.

5. The oxygen-consuming electrode according to claim 1, wherein the coating comprises from 2 to 10 parts by weight of the at least one fluorine-containing polymer, from 30 to 70 parts by weight of the silver compound, and from 15 to 50 parts by weight of the hydrophilic caustic alkali-resistant filler.

6. The oxygen-consuming electrode according to claim 1, wherein the electrical conductivity of the caustic alkali-resistant filler is less than 1000 S/cm.

7. The oxygen-consuming electrode according to claim 6, wherein the electrical conductivity of the caustic alkali-resistant filler is less than 100 S/cm.

8. The oxygen-consuming electrode according to claim 1, wherein the average particle diameter of the caustic alkali-resistant filler is from 10 to 150 μm.

9. The oxygen-consuming electrode according to claim 1, wherein the caustic alkali-resistant filler comprises no more than 20% of a proportion of fines having a particle diameter of less than 10 μm.

10. The oxygen-consuming electrode according to claim 9, wherein the proportion of fines having a particle diameter of less than 10 μm is not more than 5%.

11. The oxygen-consuming electrode according to claim 5, wherein the caustic alkali-resistant filler comprises no more than 5% of a proportion of fines having a particle diameter of less than 10 μm.

12. The oxygen-consuming electrode according to claim 1, wherein the caustic alkali-resistant filler comprises no more than 5% of a proportion of fines having a particle diameter of less than 1 μm.

13. The oxygen-consuming electrode according to claim 12, wherein the caustic alkali-resistant filler comprises no more than 1% of a proportion of fines having a particle diameter of less than 1 μm.

14. The oxygen-consuming electrode according to claim 1, wherein the caustic alkali-resistant filler is selected from the group consisting of a metal oxide, a metal nitride, a metal carbide, and mixtures thereof

15. The oxygen-consuming electrode according to claim 1, wherein the caustic alkali-resistant filler is selected from the group consisting of: a zirconium oxide, a titanium oxide, a manganese oxide, an iron oxide, a nickel oxide, a cobalt oxide, a chromium oxide, a yttrium oxide, a tungsten oxide, a cerium oxide, an oxide of a rare earth metal, a mixed metal oxide, a perovskite, a boron nitride, a silicon nitride, a titanium nitride, an aluminium nitride, a silicon carbide, a titanium carbide, a chromium carbide, a tungsten carbide, a titanium carbo nitride (TiCN), and mixtures thereof.

16. The oxygen-consuming electrode according to claim 15, wherein the manganese oxide is Mn₂O₃ or Mn₅O₈; the iron oxide is Fe₂O₃ or Fe₃O₄, the mixed metal oxide is CoAl2O4 or Co(AlCr)204; the perovskite is LaNiO₃, ZnFe₂O₄ (pigment yellow 119), or Cu(FeCr)₂O₄; and the chromium carbide is CrC or Cr₃C₂.

17. The oxygen-consuming electrode according to claim 15, wherein the caustic alkali-resistant filler is selected from the group consisting of a zirconium oxide, a tungsten oxide, and mixtures thereof.

18. A chloralkali electrolysis apparatus comprising the oxygen-consuming electrode according to claim 1 as an oxygen-consuming cathode.

19. A fuel cell comprising the oxygen-consuming electrode according to claim 1.

20. A metal/air battery comprising the oxygen-consuming electrode according to claim 1.
